(19) United States
(12) Patent Application Publication
(10) Pub. No.: US 2013/0285980 A1
(43) Pub. Date: Oct. 31, 2013

(54) COORDINATE INPUT DEVICE

(71) Applicant: ALPS ELECTRIC CO., LTD., Tokyo (JP)

(72) Inventor: Junichiro Oya, Miyagi-ken (JP)

(21) Appl. No.: 13/930,762

(22) Filed: Jun. 28, 2013

Related U.S. Application Data
(63) Continuation of application No. PCT/JP2012/050088, filed on Jun. 5, 2012.

(30) Foreign Application Priority Data
Jan. 11, 2011 (JP) 2011-003272

(51) Int. Cl. G06F 3/044

(52) U.S. Cl. CPC G06F 3/044
USPC 345/174

(57) ABSTRACT

An electrostatic capacitance-type coordinate input device includes a first electrode group including a plurality of first electrode arrays arrayed at predetermined intervals, and a second electrode group including a plurality of second electrode arrays arrayed at predetermined intervals. The first electrode group and the second electrode group are insulated from each other, and laid so as to intersect with each other. In the first electrode array, a plurality of first electrodes are linked in a first direction. In the second electrode array, a plurality of second electrodes are linked in a second direction.

### CLAIM OF PRIORITY

This application is a Continuation of International Application No. PCT/JP2012/050088 filed on Jan. 5, 2012, which claims benefit of Japanese Patent Application No. 2011-003272 filed on Jan. 11, 2011. The entire contents of each application noted above are hereby incorporated by reference.

### BACKGROUND

1. Field of the Disclosure

The present disclosure relates to a coordinate input device having a contact surface, with which the fingertip or the like of an operator is able to be in contact, and detecting the contact position of the fingertip or the like on the contact surface.

2. Description of the Related Art

In recent years, there has been a great increase in the number of notebook-sized personal computers (notebook PCs), cellular phones, and mobile terminals. In the field of general computers, as a device causing a cursor to move on a display screen, in the past, mice have been widely used. However, in a field where emphasis is put on mobility, in many cases coordinate input devices are used each of which has a contact surface, with which the fingertip or the like of an operator is able to be in contact, and detects the contact position of the fingertip or the like on the contact surface. The coordinate input devices are very common in touch-pads and the like used for the input of personal computers, and also applied to the touch panels of portable devices, various kinds of terminals, and the like, using transparent substrates and transparent electrodes.

Examples of the coordinate input devices include a pressure-sensitive type detecting the contact position of a fingertip on a contact surface owing to a change in pressure and an electrostatic capacitance-type detecting the contact position of a fingertip on a contact surface owing to a change in electrostatic capacitance. When the electrostatic capacitance-type coordinate input device from among these two types of coordinate input device is used as a device causing a cursor to move, it may be possible for a user to move the cursor only by tracing lightly over a contact surface, unlike a pressure-sensitive type coordinate input device. Therefore, the electrostatic capacitance-type coordinate input device is easy to use, and preferred by many users.

As a touch panel that has been known in the past, in Japanese Unexamined Patent Application Publication No. 2010-182027, a touch panel 900 has been proposed where a first electrode group 991 and a second electrode group 992 are caused to intersect with each other using a transparent substrate 910, as illustrated in FIG. 15. In one surface of the transparent substrate 910, the touch panel 900 includes the first electrode group 991 including a plurality of first electrodes 921 in each of which a plurality of first electrode surfaces 921S are electrically connected in a first direction DY and the second electrode group 992 including a plurality of second electrodes 922 in each of which a plurality of second electrode surfaces 922S are electrically connected in a second direction DX, and the first electrode surface 921S and the second electrode surface 922S are formed in the shapes of rectangles or rhombi, and disposed so as to be adjacent to each other. In addition, a transparent insulation film 930 including a plurality of contact holes 930H is provided so as to cover the first electrode group 991 and the second electrode group 992, and furthermore, a conductive film 950 is provided on the top surface of the transparent insulation film 930. In addition, through the contact holes 930H and the conductive film 950, the plural second electrode surfaces 922S in the second electrode 922 are electrically connected.

In addition, a predetermined voltage signal is applied between the plural first electrodes 921 configuring the first electrode group 991 and the plural second electrodes 922 configuring the second electrode group 992, and the electrostatic capacitance of each of the plural first electrode surfaces 921S and the electrostatic capacitance of each of the plural second electrode surfaces 922S are measured. In addition, when the contact of a finger, a stylus, or the like has occurred, a contact position is identified from a phenomenon where the electrostatic capacitances of the first electrode surface 921S and the second electrode surface 922S nearest to that contact position change, and output as the position information of a X-Y coordinate system.

However, since, in such a configuration as Japanese Unexamined Patent Application Publication No. 2010-182027, the first electrode surface 921S and the second electrode surface 922S are formed throughout the entire surfaces of electrodes, base capacitances between the first electrode surface 921S and a ground and between the second electrode surface 922S and the ground become large. Therefore, when a predetermined voltage is applied between the first electrode 921 and the second electrode 922, it takes time to apply a voltage to this base capacitance. Therefore, there has been a problem that a response speed for detecting changes in the electrostatic capacitances of the first electrode surface 921S and the second electrode surface 922S adjacent to each other becomes reduced. In addition, there has also been a problem that when capacitance at the time of detection is large, electric power consumption increases in response to that amount.

### SUMMARY

The present invention provides a coordinate input device of an electrostatic capacitance type including a first electrode group including a plurality of first electrode arrays arranged at predetermined intervals, and a second electrode group including a plurality of second electrode arrays arranged at predetermined intervals, wherein the first electrode group and the second electrode group are insulated from each other, and laid so as to intersect with each other, a plurality of first electrodes are linked in a first direction in the first electrode array, a plurality of second electrodes are linked in a second direction in the second electrode array, the first electrode is provided so as to be displaced from the second electrode in planar view, and a shape of the first electrode is in a ring shape.

Accordingly, in the coordinate input device, by causing the shape of the first electrode to be in the ring shape, it may be possible to reduce the electrode area of the first electrode, compared with a case where the electrode surface of the first electrode is formed throughout the entire surface. Therefore, it may be possible to reduce base capacitance between the first electrode and a ground. Owing to this, it may be possible to accelerate a response speed in the detection of a capacitance change, and since capacitance at the time of detection is small, it may also be possible to reduce electric power consumption.

### BRIEF DESCRIPTION OF THE DRAWINGS

FIG. 1 is a diagram explaining a coordinate input device of a first embodiment of the present invention and a configuration diagram enlarging a portion of a plan view seen from a first electrode group side;

FIG. 2 is a diagram explaining the coordinate input device of the first embodiment of the present invention and a cross-sectional view taken along a line II-II illustrated in FIG. 1;

FIG. 3 is a diagram explaining a coordinate input device of a second embodiment of the present invention and a configuration diagram enlarging a portion of a plan view seen from a first electrode group side;

FIG. 4 is a diagram explaining a coordinate input device of a third embodiment of the present invention and a configuration diagram enlarging a portion of a plan view seen from a first electrode group side;

FIG. 5 is a diagram explaining the coordinate input device of the third embodiment of the present invention and a cross-sectional view taken along a line V-V illustrated in FIG. 4;

FIG. 6 is a diagram explaining a coordinate input device of a fourth embodiment of the present invention and a configuration diagram enlarging a portion of a plan view seen from a first electrode group side;

FIG. 7 is a diagram explaining the coordinate input device of the fourth embodiment of the present invention and a cross-sectional view taken along a line VII-VII illustrated in FIG. 6;

FIG. 8 is a diagram explaining a coordinate input device of a fifth embodiment of the present invention and a configuration diagram enlarging a portion of a plan view seen from a first electrode group side;

FIG. 9 is a diagram explaining the coordinate input device of the fifth embodiment of the present invention and a cross-sectional view taken along a line IX-IX illustrated in FIG. 8;

FIG. 10 is a diagram explaining a coordinate input device of a sixth embodiment of the present invention and a configuration diagram enlarging a portion of a plan view seen from a first electrode group side;

FIG. 11 is a diagram explaining the coordinate input device of the sixth embodiment of the present invention and a cross-sectional view taken along a line XI-XI illustrated in FIG. 10;

FIGS. 12A to 12D are configuration diagrams explaining a first example of a modification to the coordinate input device of the first embodiment of the present invention and plan views illustrating portions of a first electrode and a second electrode;

FIGS. 13A and 13B are configuration diagrams explaining a third example of a modification to the coordinate input device of the second embodiment of the present invention and plan views illustrating portions of a first electrode and a second electrode;

FIGS. 14A and 14B are configuration diagrams explaining a fourth example of a modification to the coordinate input device of the second embodiment of the present invention and plan views illustrating portions of a first electrode and a second electrode; and

FIG. 15 is a diagram explaining a touch panel of the related art and a plan view enlarging a portion of the touch panel viewed from a transparent substrate side.

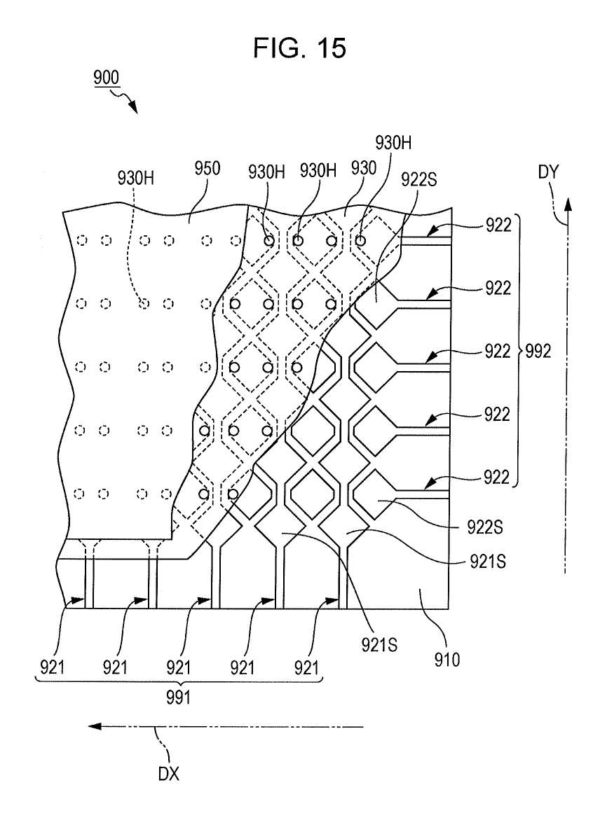

### DESCRIPTION OF THE PREFERRED EMBODIMENTS

Hereinafter, embodiments of the present invention will be described in detail with reference to accompanying drawings.

### First Embodiment

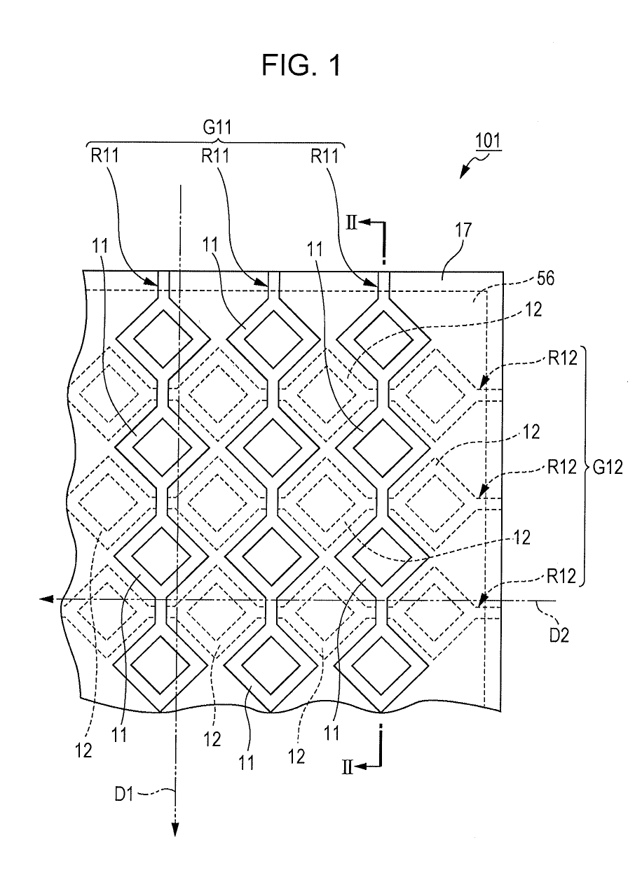

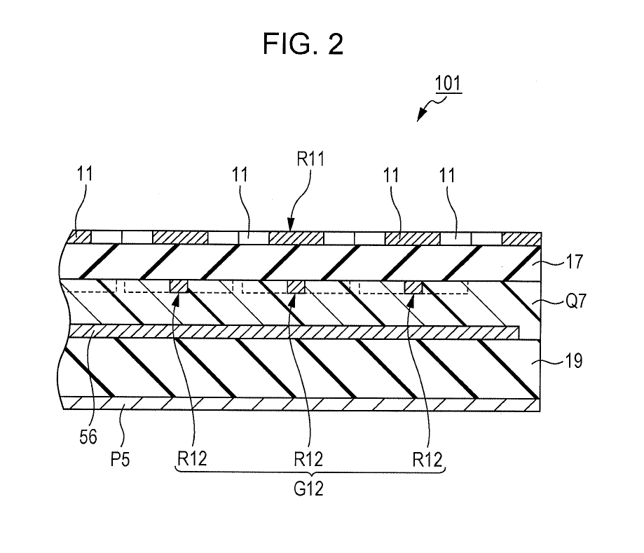

FIG. 1 is a diagram explaining a coordinate input device of a first embodiment of the present invention and a configuration diagram enlarging a portion of a plan view seen from a first electrode group G11 side. FIG. 2 is a diagram explaining the coordinate input device of the first embodiment of the present invention and a cross-sectional view taken along a line II-II illustrated in FIG. 1.

As illustrated in FIG. 1 and FIG. 2, a coordinate input device 101 of the first embodiment of the present invention mainly includes a first electrode group G11, a second electrode group G12 laid so as to intersect with the first electrode group G11, and an insulation layer 17 used for insulating the first electrode group G11 and the second electrode group G12 from each other, the first electrode group G11, the second electrode group G12, and the insulation layer 17 being provided on one surface side of a base material 19. In addition, the coordinate input device 101 includes an intermediate layer Q7 provided between a ground electrode portion 56 and the first electrode group G11 and second electrode group G12, and a wiring portion P5 used for connecting the coordinate input device 101 to a control unit or another device.

As illustrated in FIG. 1, the first electrode group G11 includes a plurality of first electrode arrays R11, and the individual first electrode arrays R11 are arrayed at predetermined intervals. In addition, each of the first electrode arrays R11 has a shape where a plurality of first electrodes 11 are connected using linking portions, and forms a linked body where the plural first electrodes 11 are arranged in a first direction D1. In addition, the outline of the first electrode 11 is in a square shape, and the shape of the electrode surface thereof is in a ring shape where no central portion exists.

As illustrated in FIG. 1, the second electrode group G12 includes a plurality of second electrode arrays R12, and the individual second electrode arrays R12 are arrayed at predetermined intervals. In addition, each of the second electrode arrays R12 has a shape where a plurality of second electrodes 12 are connected using linking portions, and forms a linked body where the plural second electrodes 12 are arranged in a second direction D2. In addition, in the same way as the first electrode group G11, the outline of the second electrode 12 is in a square shape, and the shape of the electrode surface thereof is in a ring shape where no central portion exists.

In addition, the first electrode group G11 and the second electrode group G12 are insulated from each other owing to the after-mentioned insulation layer 17, and laid so as to intersect with each other when being seen through in planar view from the first electrode group G11 side. In addition, when being seen through in planar view from the first electrode group G11 side, the first electrode 11 and the second electrode 12 are provided so as to be displaced from each other, and the first electrodes 11 and the second electrodes 12 are disposed in a tiled manner.

In addition, since the first electrode 11 and the second electrode 12 have square shapes and the first direction D1 of the first electrode array R11 and the second direction D2 of the second electrode array R12 are perpendicular to each other, it may be possible to maintain a given distance between the sides of the square shapes of the first electrode 11 and the second electrode 12 disposed in a tiled manner and adjacent to each other.

As illustrated in FIG. 2, in the insulation layer 17, the first electrode group G11 is provided on one side of the insulation layer 17, and the second electrode group G12 is provided on the other side of the insulation layer 17. In addition, for the insulation layer 17, an insulating synthetic resin material is used where an epoxy resin is infiltrated into a glass woven fabric. In addition, the first electrode group G11 and the second electrode group G12 include copper or a copper alloy, and are subjected to patterning using photolithography.

In addition, the ground electrode portion 56 is formed on one surface side of the base material 19, on which the first electrode group G11 and the second electrode group G12 are provided, and the wiring portion P5 used for connecting the coordinate input device 101 to the control unit or another device is provided on the other surface side of the base material 19. In the same way as the insulation layer 17, for the base material 19, an insulating synthetic resin material is used where an epoxy resin is infiltrated into a glass woven fabric. In addition, between the ground electrode portion 56 and the first electrode group G11 and second electrode group G12, the intermediate layer Q7 is provided that includes an insulating synthetic resin material where an epoxy resin is infiltrated into a glass woven fabric.

The ground electrode portion 56 and the wiring portion P5 include copper or a copper alloy, and are subjected to patterning using photolithography. In addition, the first electrode group G11, the second electrode group G12, and the ground electrode portion 56 are electrically connected to the wiring portion P5 using through-holes (not illustrated). It may be possible to easily accomplish the manufacture of such individual configurations as described above, using a so-called four-layer printed-circuit board (PCB). In addition, in some cases, on the first electrode group G11 side to be subjected to the contact of a finger, a stylus, or the like and a wiring portion P5 side, insulating resist films are coated for the sake of prevention of oxidation in electrodes and wiring lines or protection in a soldering process.

In the coordinate input device 101 of the present invention, configured in such a way as described above, when the contact of a finger, a stylus, or the like has occurred owing to an operator, electrostatic capacitance between the first electrode 11 located nearest to that contact position and the second electrode 12 through the insulation layer 17 changes between before and after the contact of the finger or the like. Accordingly, the coordinate input device 101 is an electrostatic capacitance-type coordinate input device capable of identifying the contact position of the finger or the like from this capacitance change and obtaining the contact position as the position information of the X-Y coordinate system. However, since this electrostatic capacitance change is small capacitance compared with reference capacitance including base capacitance in a normal state where no contact occurs, it is desirable to reduce the reference capacitance. The base capacitance as is defined here indicates capacitance between the first electrode 11 and the ground and capacitance between the second electrode 12 and the ground.

Therefore, in the coordinate input device 101 of the present invention, the shape of the electrode surface of the first electrode 11 and the shape of the electrode surface of the second electrode 12 are caused to be in ring shapes where no central portion exists. Accordingly, compared with a case where the electrode surface of the first electrode 11 and the electrode surface of the second electrode 12 are formed throughout the entire surfaces, it may be possible to reduce the electrode area of the first electrode 11 and the electrode area of the second electrode 12. Therefore, it may be possible to reduce the base capacitance between the first electrode 11 and the ground and the base capacitance between the second electrode 12 and the ground. Since, owing to this, the reference capacitance becomes reduced, detection capacitance affecting a response speed at the time of measurement becomes reduced, and it may be possible to accelerate a response speed in the detection of a capacitance change. In addition, since detection capacitance at the time of detection is small, it may also be possible to reduce electric power consumption at the time of measurement.

In addition, since the reference capacitance becomes reduced and the detection capacitance becomes reduced, it may be possible to reduce a load on an IC for detecting a capacitance change in this detection capacitance, which has been detected. Owing to this, it may be possible to reduce a noise the IC emits.

In addition, since, owing to the contact of a finger, a stylus, or the like due to the operator, a capacitance between the finger, the stylus, or the like and the first electrode 11 and a capacitance between the finger, the stylus, or the like and the second electrode 12 are produced, it may be possible to reduce these capacitances by causing the shape of the electrode surface of the first electrode 11 and the shape of the electrode surface of the second electrode 12 to be in ring shapes where no central portion exists. In particular, on a side to be in directly contact with the finger, the stylus, or the like, it may be possible to reduce a capacitance between the finger, the stylus, or the like and the first electrode 11. Owing to this, it may be possible to reduce the influence of a noise travelling from the operator through this capacitance.

In addition, in the coordinate input device 101 of the present invention, the first electrode group G11 and the second electrode group G12 are laid so as to intersect with each other when being seen through in planar view from the first electrode group G11 side. In particular, when being seen through in planar view from the first electrode group G11 side, the first electrode group G11 and the second electrode group G12 are disposed in a tiled manner. Therefore, it may be possible to evenly dispose the first electrode 11 and the second electrode 12. In addition, since the first direction D1 and the second direction D2 are perpendicular to each other, it may be possible to cause the shapes of the first electrode 11 and the second electrode 12 to be in the same shape. Accordingly, it may be possible to cause the base capacitance between the first electrode 11 and the ground and the base capacitance between the second electrode 12 and the ground to be equal to each other, and it may be possible to maintain a given distance between the first electrode 11 and the second electrode 12 adjacent to each other. Therefore, it may be possible to cause interelectrode capacitance to be equal. Since, owing to this, it may be possible to cause the reference capacitance to be equal, the reference capacitance including the base capacitance to be detected and the interelectrode capacitance, it may be possible to precisely detect a capacitance change to be detected when the operator performs an operation.

In particular, in the coordinate input device 101 of the present invention, the first electrode 11 and the second electrode 12 have square shapes and the first direction D1 of the first electrode array R11 and the second direction D2 of the second electrode array R12 are perpendicular to each other. Therefore, it may be possible to cause the shapes of the first electrode 11 and the second electrode 12 to be in the same shape, and it may be possible to maintain a given distance between the sides of the square shapes of the first electrode 11 and the second electrode 12 disposed in a tiled manner and adjacent to each other when being seen through in planar view. Since, owing to this, it may be possible to cause the reference capacitance including the interelectrode capacitance to be detected to be more equal, it may be possible to more precisely detect a capacitance change to be detected when the operator performs an operation.

In addition, since the first direction D1 and the second direction D2 are perpendicular to each other, and the first electrode 11 and the second electrode 12 are evenly disposed in a tiled manner, it may be easy to design a coordinate input device at the manufacture thereof, and it may be possible to enhance dimension accuracy. In addition, it may become easy to design a circuit used for detection.

In addition, in the coordinate input device 101 of the present invention, since the first electrode group G11 and the second electrode group G12 are provided with the insulation layer 17 sandwiched therebetween, it may be possible to insulate the first electrode group G11 and the second electrode group G12, which intersect with each other, from each other using only the insulation layer 17. Owing to this, it may be possible to manufacture a coordinate input device using a simple process, compared with a case where an insulation film and a contact hole are used for insulation in each of all the intersecting points in such a way as the related art. Furthermore, since no contact hole is used for linking the plural first electrodes 11 or the plural second electrodes 12 to each other, it may be possible to reduce the wiring resistance of the first electrode array R11 or the second electrode array R12. Owing to this, a resistance value affecting a response speed at the time of measurement becomes reduced, and it may be possible to accelerate a response speed in the detection of a capacitance change.

Owing to this, in the coordinate input device 101 of the present invention, by causing the shape of the first electrode 11 to be in a ring shape, it may be possible to reduce the electrode area of the first electrode 11, compared with a case where the electrode surface of the first electrode 11 is formed throughout the entire surface. Therefore, it may be possible to reduce the base capacitance between the first electrode 11 and the ground. Owing to this, it may be possible to accelerate a response speed in the detection of a capacitance change, and since capacitance at the time of detection is small, it may also be possible to reduce electric power consumption.

In addition, by causing the shape of the second electrode 12 to be in a ring shape, it may also be possible to reduce the electrode area of the second electrode 12, compared with a case where the electrode surface of the second electrode 12 is formed throughout the entire surface. Therefore, it may be possible to reduce the base capacitance between the second electrode 12 and the ground. Owing to this, it may be possible to further accelerate a response speed in the detection of a capacitance change, and since capacitance at the time of detection is smaller, it may also be possible to further reduce electric power consumption.

In addition, since the first direction D1 and the second direction D2 are perpendicular to each other, it may be possible to cause the shapes of the first electrode 11 and the second electrode 12 to be in the same shape, and it may be possible to evenly dispose the first electrode 11 and the second electrode 12. Therefore, since it may be possible to cause the base capacitance between the first electrode 11 and the ground and the base capacitance between the second electrode 12 and the ground to be equal to each other, and it may be possible to maintain a given distance between the first electrode 11 and the second electrode 12, it may be possible to cause the interelectrode capacitance to be equal. Since, owing to this, it may be possible to cause the reference capacitance to be detected to be equal, it may be possible to precisely detect a capacitance change to be detected when the operator performs an operation.

In addition, since the outlines of the first electrode 11 and the second electrode 12 are in square shapes, it may be possible to cause the shapes of the first electrode 11 and the second electrode 12 to be equal to each other, and it may be possible to maintain a same distance between the first electrode 11 and the second electrode 12 adjacent to each other when being seen through in planar view. Since, owing to this, it may be possible to cause the reference capacitance to be detected to be more equal, it may be possible to more precisely detect a capacitance change to be detected when the operator performs an operation.

In addition, since the first electrode group G11 and the second electrode group G12 are provided with the insulation layer 17 sandwiched therebetween, it may be possible to insulate the first electrode group G11 and the second electrode group G12, which intersect with each other, from each other using the insulation layer 17. Owing to this, it may be possible to manufacture a coordinate input device using a simple process, compared with a case where an insulation film and a contact hole are used for insulation in each of all the intersecting points, and furthermore, since no contact hole is used, it may be possible to reduce wiring resistance.

### Second Embodiment

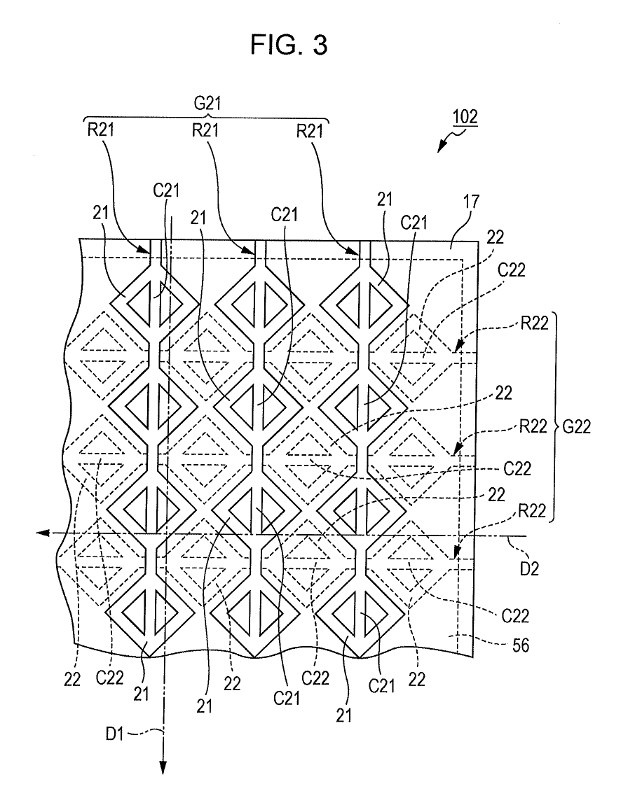

FIG. 3 is a diagram explaining a coordinate input device 102 of a second embodiment of the present invention and a configuration diagram enlarging a portion of a plan view seen from a first electrode group G21 side. The coordinate input device 102 of the second embodiment of the present invention is different from the coordinate input device 101 of the first embodiment of the present invention in the shape of the electrode surface of a first electrode 21 of a first electrode group G21 and the shape of the electrode surface of a second electrode 22 of a second electrode group G22. In addition, the same symbol is assigned to the same member as the first embodiment, and the description thereof will be omitted.

In the same way as the coordinate input device 101 of the first embodiment, the coordinate input device 102 of the second embodiment of the present invention mainly includes the first electrode group G21, the second electrode group G22 laid so as to intersect with the first electrode group G21, and the insulation layer 17 used for insulating the first electrode group G21 and the second electrode group G22 from each other, the first electrode group G21, the second electrode group G22, and the insulation layer 17 being provided on one surface side of the base material 19. In addition, while not illustrated, the coordinate input device 102 includes the intermediate layer Q7 provided between a ground electrode portion 56 with each of the first electrode group G21 and the second electrode group G22 and the first electrode group G21 and second electrode group G22, and the wiring portion P5 used for connecting the coordinate input device 102 to a control unit or another device. In addition, the disposition relationship of each of the individual configuration elements is the same as the coordinate input device 101 of the first embodiment.

As illustrated in FIG. 3, the first electrode group G21 includes a plurality of first electrode arrays R21, and the individual first electrode arrays R21 are arrayed at predetermined intervals. In addition, each of the first electrode arrays R21 has a shape where a plurality of the first electrodes 21 are connected using linking portions, and forms a linked body where the plural first electrodes 21 are arranged in the first direction D1. In addition, the outline of the first electrode 21 is in a square shape, and the shape of the electrode surface thereof is in a shape where a first connection portion C21 is provided in the first direction D1 within a ring shape in which no central portion exists.

As illustrated in FIG. 3, the second electrode group G22 includes a plurality of second electrode arrays R22, and the individual second electrode arrays R22 are arrayed at predetermined intervals. In addition, each of the second electrode arrays R22 has a shape where a plurality of the second electrodes 22 are connected using linking portions, and forms a linked body where the plural second electrodes 22 are arranged in the second direction D2. In addition, in the same way as the first electrode group G21, the outline of the second electrode 22 is in a square shape, and the shape of the electrode surface thereof is in a shape where a second connection portion C22 is provided in the second direction D2 within a ring shape in which no central portion exists.

While, by providing the first connection portion C21 in the first direction D1 within the ring shape of the first electrode 21, the base capacitance may be expected to slightly increase, it may be possible to greatly reduce the wiring resistance of the first electrode array R21. Owing to this, a resistance value affecting a response speed at the time of measurement becomes reduced, and it may be possible to accelerate a response speed in the detection of a capacitance change. In the same way, by providing the second connection portion C22 in the second direction D2 within the ring shape of the second electrode 22, it may be possible to greatly reduce the wiring resistance of the second electrode array R22, and it may be possible to accelerate a response speed at the time of measurement.

In particular, in the case of a material whose specific resistance is high, examples of the material including an inorganic transparent conductive material, such as, for example, indium tin oxide (ITO), and a silver conductive paste other than copper or a copper alloy serving as an electrode material used in the coordinate input device 102 of the second embodiment, a great effect of reducing the resistance value of a wiring line is obtained, and an effect becomes prominent that is due to providing the connection portion within the ring shape of the electrode surface.

From the above, in the coordinate input device 102 of the present invention, since, by causing the shapes of the first electrode 21 and the second electrode 22 to be in ring shapes, it may be possible to reduce the electrode areas of the first electrode 21 and the second electrode 22, compared with a case where the electrode surface of the first electrode 21 and the electrode surface of the second electrode 22 are formed throughout the entire surfaces. Therefore, it may be possible to reduce the base capacitance between the first electrode 21 and the ground and the base capacitance between the second electrode 22 and the ground. Owing to this, it may be possible to accelerate a response speed in the detection of a capacitance change, and since detection capacitance at the time of detection is smaller, it may also be possible to further reduce electric power consumption.

In addition, the first connection portion C21 is provided in the first direction D1 within the ring shape of the first electrode 21, and the second connection portion C22 is provided in the second direction D2 within the ring shape of the second electrode 22. Therefore, it may be possible to reduce the wiring resistances of the first electrode array R21 and the second electrode array R22. Since, owing to this, a wiring resistance affecting a response speed at the time of measurement becomes further reduced, it may be possible to further accelerate a response speed at the time of detection.

### Third Embodiment

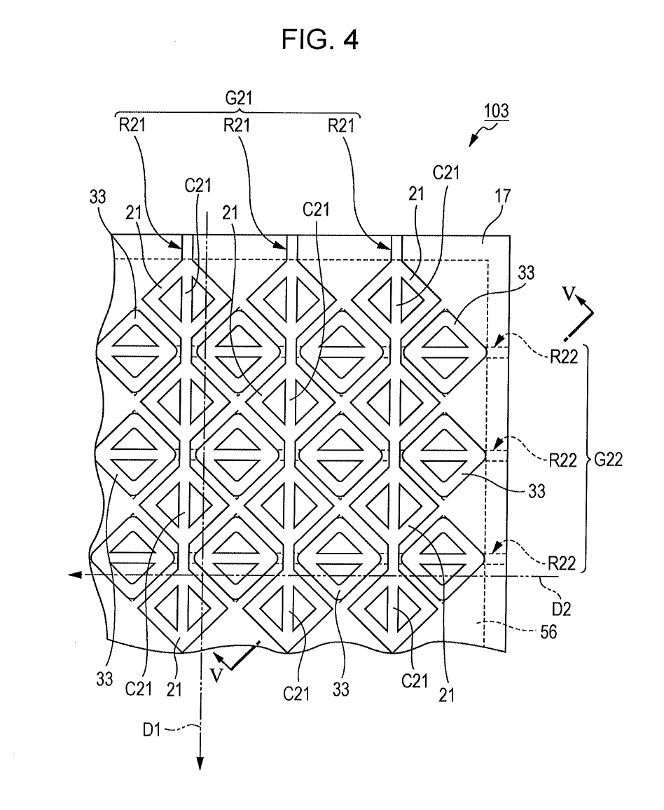

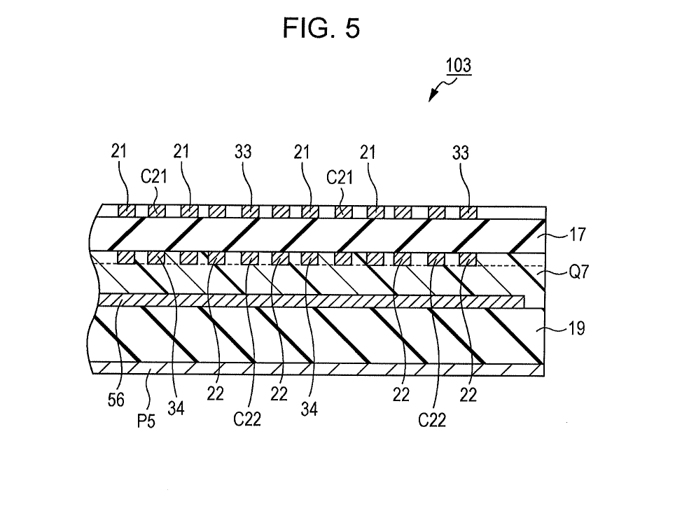

FIG. 4 is a diagram explaining a coordinate input device 103 of a third embodiment of the present invention and a configuration diagram enlarging a portion of a plan view seen from a first electrode group G31 side. FIG. 5 is a diagram explaining the coordinate input device 103 of the third embodiment of the present invention and a cross-sectional view taken along a line V-V illustrated in FIG. 4. The coordinate input device 103 of the third embodiment of the present invention is different from the coordinate input device 102 of the second embodiment of the present invention in that a third electrode 33 and a fourth electrode 34 are newly provided. In addition, the other configuration elements and the disposition relationship of each of the individual configuration elements are the same as the coordinate input device 102 of the second embodiment. In addition, the same symbol is assigned to the same member as the first embodiment and the second embodiment, and the description thereof will be omitted.

As illustrated in FIG. 4 and FIG. 5, on one side of the insulation layer 17, the third electrode 33 is provided at a position facing the second electrode 22. In addition, the third electrode 33 has the same shape as the second electrode 22, the outline of the third electrode 33 is in a square shape, and the shape of the electrode surface thereof is a ring shape where no central portion exists, and in a shape where a connection portion is provided within the ring shape.

As illustrated in FIG. 4 and FIG. 5, on the other side of the insulation layer 17, the fourth electrode 34 is provided at a position facing the first electrode 21. In addition, the fourth electrode 34 has the same shape as the first electrode 21, the outline of the fourth electrode 34 is in a square shape, and the shape of the electrode surface thereof is a ring shape where no central portion exists, and in a shape where a connection portion is provided within the ring shape.

From the above, in the coordinate input device 103 of the third embodiment of the present invention, since, on one side of the insulation layer 17, the third electrode 33 is provided at a position facing the second electrode 22, the second electrode 22 and the third electrode 33 are capacitively coupled to each other. Therefore, it may be possible to obtain a state electrically equal to a case where the second electrode 22 is provided in the same plane surface as the first electrode 21. Owing to this, capacitance formed between the first electrode 21 and the second electrode 22 becomes large, and it may be possible to make the reference capacitance including the interelectrode capacitance to be detected large. Therefore, it may be possible to improve detection sensitivity.

In addition, since, on the other side of the insulation layer 17, the fourth electrode 34 is provided at a position facing the first electrode 21, the first electrode 21 and the fourth electrode 34 are capacitively coupled to each other. Therefore, it may be possible to obtain a state electrically equal to a case where the first electrode 21 is provided in the same plane surface as the second electrode 22. Owing to this, the base capacitance between the first electrode 21 and the ground and the base capacitance between the second electrode 22 and the ground become equal to each other, and it may be possible to cause the reference capacitance including the base capacitance to be detected to be equal. Therefore, it may be possible to precisely detect a capacitance change to be detected when the operator performs an operation.

### Fourth Embodiment

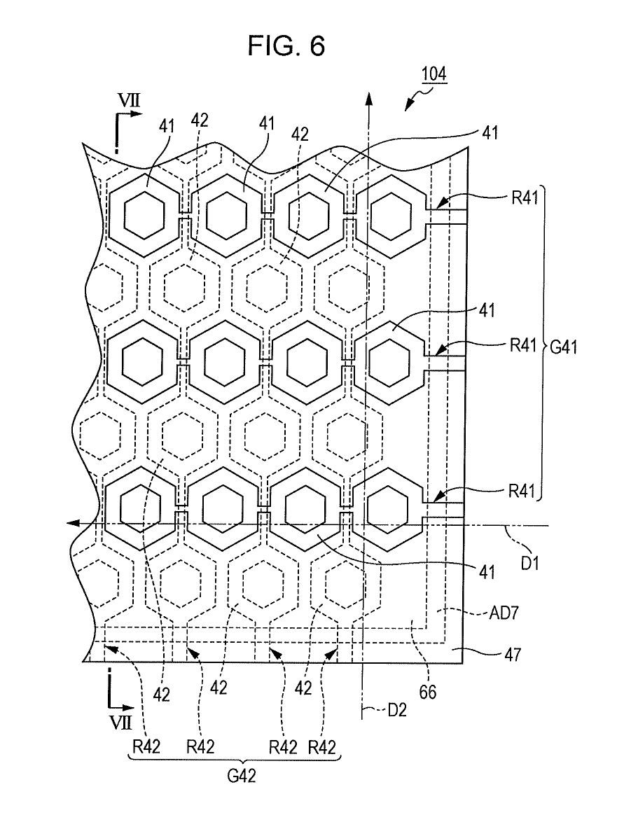

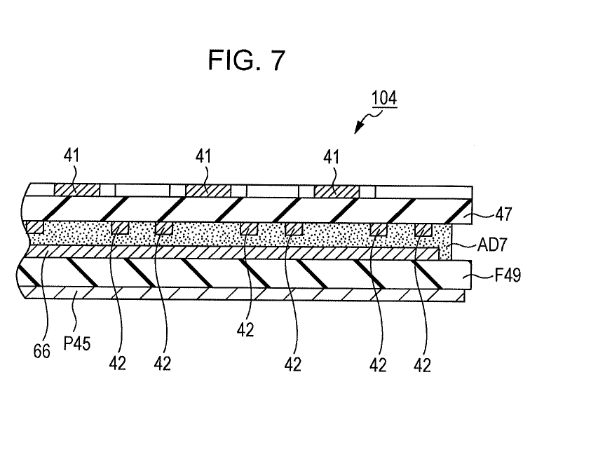

FIG. 6 is a diagram explaining a coordinate input device 104 of a fourth embodiment of the present invention and a configuration diagram enlarging a portion of a plan view seen from a first electrode group G41 side. FIG. 7 is a diagram explaining the coordinate input device 104 of the fourth embodiment of the present invention and a cross-sectional view taken along a line VII-VII illustrated in FIG. 6. The coordinate input device 104 of the fourth embodiment of the present invention is different from the coordinate input device 101 of the first embodiment of the present invention in the shape of the electrode surface of a first electrode 41 of a first electrode group G41 and the shape of the electrode surface of a second electrode 42 of a second electrode group G42, and also different from the coordinate input device 101 of the first embodiment of the present invention in that a flexible base material F49 is used. In addition, the same symbol is assigned to the same member as the first embodiment, and the description thereof will be omitted.

As illustrated in FIG. 6 and FIG. 7, the coordinate input device 104 of the fourth embodiment of the present invention mainly includes the first electrode group G41, the second electrode group G42 laid so as to intersect with the first electrode group G41, and an insulation layer 47 used for insulating the first electrode group G41 and the second electrode group G42 from each other, the first electrode group G41, the second electrode group G42, and the insulation layer 47 being provided on one surface side of the flexible base material F49. In addition, the coordinate input device 104 includes a ground electrode portion 66 with each of the first electrode group G41 and the second electrode group G42, the ground electrode portion 66 being provided on the one surface side of the flexible base material F49, a wiring portion P45 used for connecting the coordinate input device 104 to a control unit or another device, the wiring portion P45 being provided on the other surface side of the flexible base material F49, and an adhesive layer AD7 used for causing the first electrode group G41 and second electrode group G42 and the flexible base material F49 to adhere to each other.

As illustrated in FIG. 6, the first electrode group G41 includes a plurality of first electrode arrays R41, and the individual first electrode arrays R41 are arrayed at predetermined intervals. In addition, each of the first electrode arrays R41 has a shape where a plurality of the first electrodes 41 are connected using linking portions, and forms a linked body where the plural first electrodes 41 are arranged in the first direction D1. In addition, the outline of the first electrode 41 is in a hexagonal shape, and the shape of the electrode surface thereof is in a ring shape where no central portion exists.

As illustrated in FIG. 6, the second electrode group G42 includes a plurality of second electrode arrays R42, and the individual second electrode arrays R42 are arrayed at predetermined intervals. In addition, each of the second electrode arrays R42 has a shape where a plurality of the second electrodes 42 are connected using linking portions, and forms a linked body where the plural second electrodes 42 are arranged in the second direction D2. In addition, in the same way as the first electrode group G41, the outline of the second electrode 42 is in a hexagonal shape, and the shape of the electrode surface thereof is in a ring shape where no central portion exists.

In addition, the first electrode group G41 and the second electrode group G42 are insulated from each other owing to the after-mentioned insulation layer 47, and laid so as to intersect with each other when being seen through in planar view from the first electrode group G41 side. In addition, when being seen through in planar view from the first electrode group G41 side, the first electrode 41 and the second electrode 42 are provided so as to be displaced from each other, and the first electrodes 41 and the second electrodes 42 are disposed in a tiled manner. In addition, the first direction D1 of the first electrode array R41 and the second direction D2 of the second electrode array R42 are perpendicular to each other.

Since, owing to this, the outlines of the first electrode 41 and the second electrode 42 are in hexagonal shapes, it may be possible to cause the first electrode 41 and the second electrode 42 to have the same shape, and it may be possible to maintain a given distance between the sides of the hexagonal shapes of the first electrode 41 and the second electrode 42 disposed in a tiled manner and adjacent to each other when being seen through in planar view. Since, owing to this, it may be possible to cause the reference capacitance including the interelectrode capacitance to be detected to be more equal, it may be possible to more precisely detect a capacitance change to be detected when the operator performs an operation.

As illustrated in FIG. 7, the first electrode group G41 is provided on one side of the insulation layer 47, the second electrode group G42 is provided on the other side of the insulation layer 47, and the insulation layer 47 is a film base material utilizing a synthetic resin material such as polyimide (PI). In addition, the first electrode group G41 and the second electrode group G42 include copper or a copper alloy, and are subjected to patterning using photolithography. It may be possible to easily accomplish the manufacture of such a configuration as described above, using a so-called double-sided flexible printed-circuit board.

The flexible base material F49 has flexibility, and utilizes a film base material utilizing a synthetic resin material such as polyimide (PI) in the same way as the insulation layer 47. In addition, the ground electrode portion 66 and the wiring portion P45 include copper or a copper alloy, and are subjected to patterning using photolithography. It may be possible to easily accomplish the manufacture of such a configuration as described above, using a so-called double-sided flexible printed-circuit board. In addition, the insulation layer 47 including the first electrode group G41 and the second electrode group G42 and the flexible base material F49 are stuck together with the adhesive layer AD7.

Owing to this, in the coordinate input device 104 of the present invention, by causing the shapes of the first electrode 41 and the second electrode 42 to be in ring shapes, it may be possible to reduce the electrode areas of the first electrode 41 and the second electrode 42, compared with a case where the electrode surface of the first electrode 41 and the electrode surface of the second electrode 42 are formed throughout the entire surfaces. Therefore, it may be possible to reduce the base capacitance between the first electrode 41 and the ground and the base capacitance between the second electrode 42 and the ground. Owing to this, it may be possible to further accelerate a response speed in the detection of a capacitance change, and since capacitance at the time of detection is smaller, it may also be possible to further reduce electric power consumption.

In addition, since the outlines of the first electrode 41 and the second electrode 42 are in hexagonal shapes, it may be possible to cause the shapes of the first electrode 41 and the second electrode 42 to be equal to each other, and it may be possible to maintain a given distance between the first electrode 41 and the second electrode 42 adjacent to each other when being seen through in planar view. Since, owing to this, it may be possible to cause the reference capacitance to be detected to be more equal, it may be possible to more precisely detect a capacitance change to be detected when the operator performs an operation.

In addition, since the flexible base material F49 having flexibility is used as a base material, it may be possible to deform the manufactured coordinate input device. Owing to this, it may be possible to correct and flatten warpage occurring at the time of manufacturing, or it may be possible to use the warpage as the curved surface portion of an applicable product.

### Fifth Embodiment

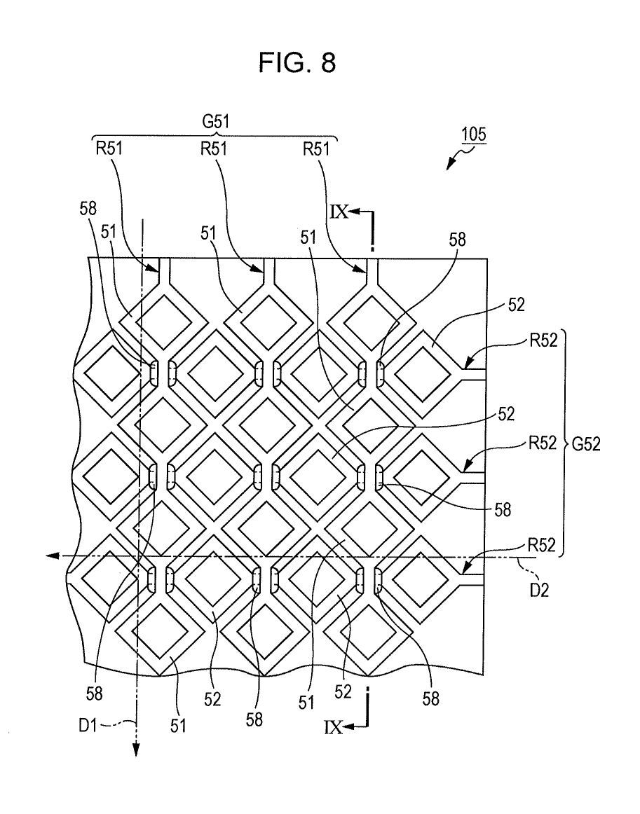

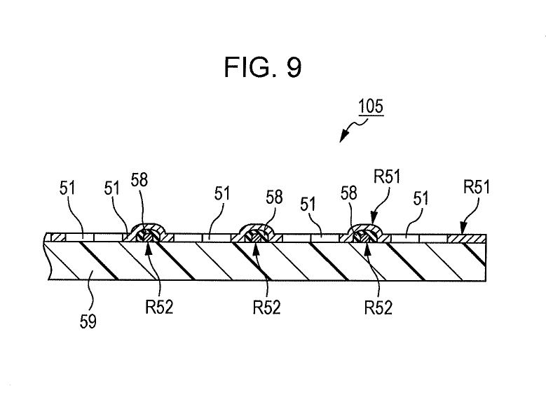

FIG. 8 is a diagram explaining a coordinate input device 105 of a fifth embodiment of the present invention and a configuration diagram enlarging a portion of a plan view seen from a first electrode group G51 side. FIG. 9 is a diagram explaining the coordinate input device 105 of the fifth embodiment of the present invention and a cross-sectional view taken along a line IX-IX illustrated in FIG. 8. The coordinate input device 105 of the fifth embodiment of the present invention is characteristically different from the coordinate input device 101 of the first embodiment of the present invention in that an insulation film portion 58 is provided in place of the insulation layer 17.

As illustrated in FIG. 8 and FIG. 9, the coordinate input device 105 of the fifth embodiment of the present invention includes a first electrode group G51, a second electrode group G52 laid so as to intersect with the first electrode group G51, and the insulation film portion 58 used for insulating the first electrode group G51 and the second electrode group G52 from each other, the first electrode group G51, the second electrode group G52, and the insulation film portion 58 being provided in one surface of a base material 59. The insulation film portion 58 is provided at a position where the first electrode group G51 and the second electrode group G52 intersect with each other.

As illustrated in FIG. 8, the first electrode group G51 includes a plurality of first electrode arrays R51, and the individual first electrode arrays R51 are arrayed at predetermined intervals. In addition, each of the first electrode arrays R51 has a shape where a plurality of first electrodes 51 are connected using linking portions, and forms a linked body where the plural first electrodes 51 are arranged in the first direction D1. In addition, the outline of the first electrode 51 is in a square shape, and the shape of the electrode surface thereof is in a ring shape where no central portion exists.

As illustrated in FIG. 8, the second electrode group G52 includes a plurality of second electrode arrays R52, and the individual second electrode arrays R52 are arrayed at predetermined intervals. In addition, each of the second electrode arrays R52 has a shape where a plurality of second electrodes 52 are connected using linking portions, and forms a linked body where the plural second electrodes 52 are arranged in the second direction D2. In addition, in the same way as the first electrode group G51, the outline of the second electrode 52 is in a square shape, and the shape of the electrode surface thereof is in a ring shape where no central portion exists.

In addition, since the insulation film portion 58 is provided in the vicinity of each linking portion where the first electrode group G51 and the second electrode group G52 intersect with each other, it may be possible to form the first electrode 51 and the second electrode 52 on the same plane surface as the one surface of the base material 59, as illustrated in FIG. 9. In addition, in planar view from the first electrode group G51 side, the first electrode 51 and the second electrode 52 are provided so as to be displaced from each other, and the first direction D1 of the first electrode array R51 and the second direction D2 of the second electrode array R52 are perpendicular to each other. Therefore, it may be possible to dispose the first electrode 51 and the second electrode 52 on a regular basis.

Since the first electrode 51 and the second electrode 52 are formed on the same plane surface as the one surface of the base material 59, it may be possible to cause the base capacitance between the first electrode 51 and the ground and the base capacitance between the second electrode 52 and the ground to be equal to each other, and it may be possible to maintain a given distance between the first electrode 51 and the second electrode 52 adjacent to each other. Therefore, it may also be possible to cause the interelectrode capacitance to be equal. In addition, since it may be possible to narrow a distance between the first electrode 51 and the second electrode 52 adjacent to each other, it may be possible to make the interelectrode capacitance large. Since, owing to this, it may be possible to cause the reference capacitance to be equal, the reference capacitance including the base capacitance to be detected and the interelectrode capacitance, and furthermore, it may be possible to make the interelectrode capacitance large, it may be possible to precisely detect a capacitance change to be detected when the operator performs an operation.

A conductive ink containing a binder resin and a conductive component is printed using a screen printing plate, dried, and solidified, and hence, the first electrode group G51 and the second electrode group G52 are manufactured. While a polyester resin, a polyethylene resin, a polyurethane resin, or the like may be used as the binder resin, if being a resin suitable for printing, any type of resin may be suitably used. In addition, as the conductive component, a metal particle such as gold, silver, copper, platinum, indium, tin, yttrium, hafnium, titan, or iron may be suitably used.

The insulation film portion 58 is formed owing to screen printing. If having an insulation property, the material of the insulation film portion 58 is not specifically limited. In addition, a resin capable of being printed may be desirable, and in particular, a thermoset resist may be suitably used that is used for semiconductor manufacture or the like.

As the base material 59, a rigid substrate such as a glass base material or a synthetic resin base material or a film substrate such as a plastic film may be used. In particular, since having flexibility, the plastic film may be suitably used. As the resin material of the plastic film or the synthetic resin substrate, a resin such as polyethylene terephthalate (PET), polypropylene (PP), polystyrene (PS), acrylic (PMMA), polyimide, or polyaramid may be used. Among them, from the point of view of flexibility and heat resistance, in particular the PET may be suitably used.

In addition, in the coordinate input device 105, the coordinate input device 105 and a control unit or another device are connected to each other using a flexible printed-circuit board (FPC) or the like (not illustrated), each of the first electrode group G51 and the second electrode group G52 is connected to the control unit, and each thereof is connected to the ground.

From the above, in the coordinate input device 105 of the present invention, by causing the shapes of the first electrode 51 and the second electrode 52 to be in ring shapes, it may be possible to reduce the electrode areas of the first electrode 51 and the second electrode 52, compared with a case where the electrode surface of the first electrode 51 and the electrode surface of the second electrode 52 are formed throughout the entire surfaces. Therefore, it may be possible to reduce the base capacitance between the first electrode 51 and the ground and the base capacitance between the second electrode 52 and the ground. Owing to this, it may be possible to further accelerate a response speed in the detection of a capacitance change, and since detection capacitance at the time of detection is smaller, it may also be possible to further reduce electric power consumption.

In addition, since the insulation film portion 58 is provided at a position where the first electrode group G51 and the second electrode group G52 intersect with each other, it may be possible to form the first electrode 51 and the second electrode 52 on the same plane surface as the one surface of the base material 59. Therefore, it may be possible to cause the base capacitance between the first electrode 51 and the ground and the base capacitance between the second electrode 52 and the ground to be equal to each other, and it may be possible to maintain a given distance between the first electrode 51 and the second electrode 52 adjacent to each other. Therefore, it may also be possible to cause the interelectrode capacitance to be equal. In addition, since it may be possible to narrow a distance between the first electrode 51 and the second electrode 52 adjacent to each other, it may be possible to make the interelectrode capacitance large. Since, owing to this, it may be possible to cause the reference capacitance to be equal, the reference capacitance including the base capacitance to be detected and the interelectrode capacitance, and furthermore, it may be possible to make the interelectrode capacitance large, it may be possible to precisely detect a capacitance change to be detected when the operator performs an operation.

### Sixth Embodiment

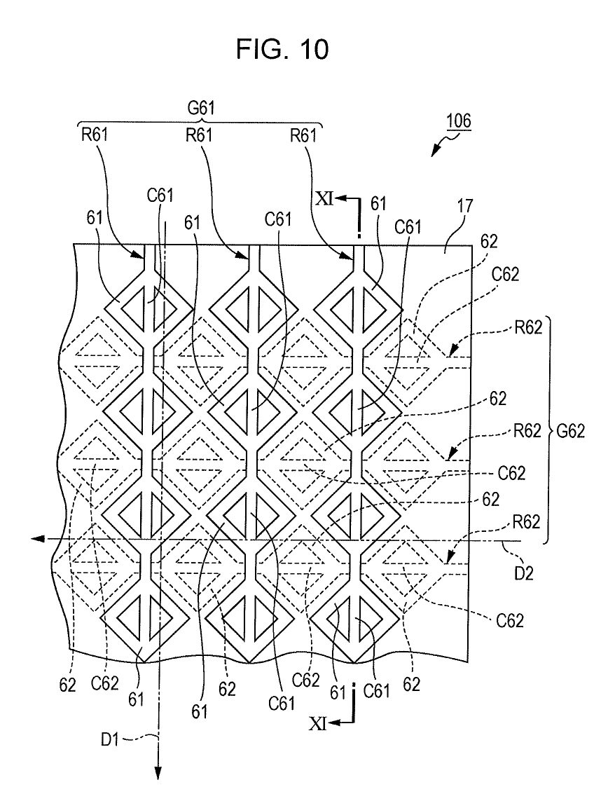

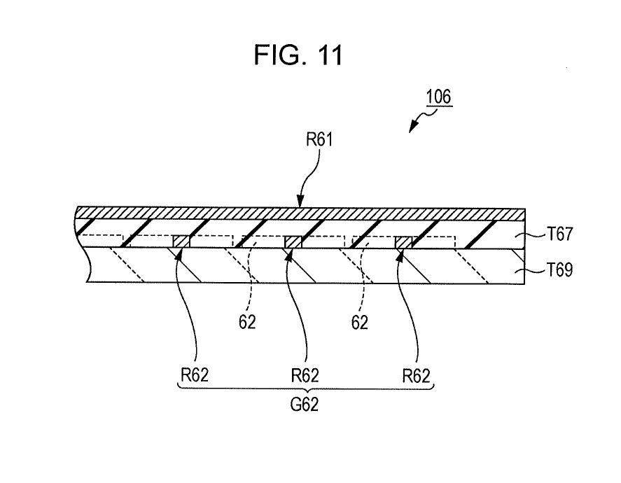

FIG. 10 is a diagram explaining a coordinate input device 106 of a sixth embodiment of the present invention and a configuration diagram enlarging a portion of a plan view seen from a first electrode group G61 side. FIG. 11 is a diagram explaining the coordinate input device 106 of the sixth embodiment of the present invention and a cross-sectional view taken along a line XI-XI illustrated in FIG. 10.

As illustrated in FIG. 10 and FIG. 11, the coordinate input device 106 of the sixth embodiment of the present invention includes a first electrode group G61, a second electrode group G62 laid so as to intersect with the first electrode group G61, and a transparent insulation layer T67 used for insulating the first electrode group G61 and the second electrode group G62 from each other, the first electrode group G61, the second electrode group G62, and the transparent insulation layer T67 being provided in one surface of a transparent base material T69. In addition, the first electrode group G61 and the second electrode group G62 are transparent electrodes.

As the first electrode group G61 and the second electrode group G62, inorganic transparent conductive materials such as indium tin oxides (ITO) may be suitably used, and subjected to patterning in a pattern shape using photolithography and wet etching after having been subjected to film formation owing to a film formation method such as sputtering. In addition, it may also be possible to manufacture the first electrode group G61 and the second electrode group G62 by subjecting an optically-transparent conductive polymer to wet coating.

In addition, the first electrode group G61 includes a first electrode array R61 including a first electrode 61 and a first connection portion C61, and is in the same shape as the shape of the first electrode group G21 in the second embodiment. In addition, in the same way, the second electrode group G62 includes a second electrode array R62 including a second electrode 62 and a second connection portion C62, and is in the same shape as the shape of the second electrode group G22 in the second embodiment.

As the transparent base material T69, a base material having translucency may be used, and a rigid substrate such as a glass base material or a synthetic resin base material or a film substrate such as a plastic film may be used. In particular, since having flexibility, the plastic film may be suitably used. As the resin material of the plastic film or the synthetic resin substrate, a resin such as polyethylene terephthalate (PET), polypropylene (PP), polystyrene (PS), acrylic, polyimide, or polyaramid may be used. Among them, from the point of view of transparency, flexibility, and heat resistance, in particular the PET may be suitably used.

As the transparent insulation layer T67, a material having an insulation property and translucency may be used, and a synthetic resin such as an epoxy resin, an acrylic resin, or a polyester resin may be suitably used.

From the above, in the coordinate input device 106 of the present invention, a base material is the transparent base material T69, an insulation layer is the transparent insulation layer T67, and the first electrode group G61 and the second electrode group G62 are the transparent electrodes. Therefore, it may be possible to visibly recognize a back side while the coordinate input device 106 is seen through. Owing to this, it may be possible to apply the coordinate input device 106 to a touch panel or the like where the coordinate input device 106 is used as the front surface of a display device, and it may be possible to use the coordinate input device 106 for more various purposes.

In addition, the present invention is not limited to the above-mentioned embodiments, and may also be implemented with being modified, for example, in the following way, and these embodiments also belong to the technical scope of the present invention.

### First Example of Modification

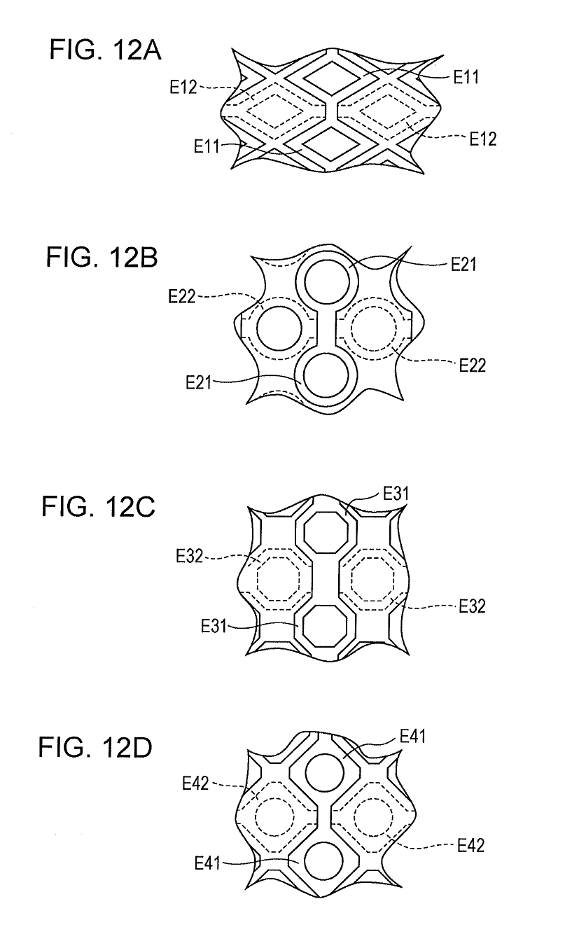

While, in the above-mentioned first embodiment, the outlines of the first electrode 11 and the second electrode 12 are in square shapes, and the shapes of the electrode surfaces thereof are in ring shapes where no central portion exists, the outlines of a first electrode E11 and a second electrode E12 may be in rhombi and the shapes thereof may also be in ring shapes, as illustrated in FIG. 12A. In addition, as illustrated in FIG. 12B, the outlines of a first electrode E21 and a second electrode E22 may be in circular shapes and the shapes thereof may also be in ring shapes. In addition, as illustrated in FIG. 12C, the outlines of a first electrode E31 and a second electrode E32 may be in octagon shapes and the shapes thereof may also be in ring shapes. In addition, as illustrated in FIG. 12D, the outlines of a first electrode E41 and a second electrode E42 may be in square shapes and the shapes thereof may also be in ring shapes where no central portion exists in a circular shape.

### Second Example of Modification

While, in the above-mentioned first embodiment, both of the shape of the electrode surface of the first electrode 11 and the shape of the electrode surface of the second electrode 12 are in ring shapes where no central portion exists, an electrode may also be formed throughout the entire surface of the electrode surface of the second electrode 12, and only in the first electrode 11, the shape of the electrode surface thereof may also be in a ring shape where no central portion exists.

### Third Example of Modification

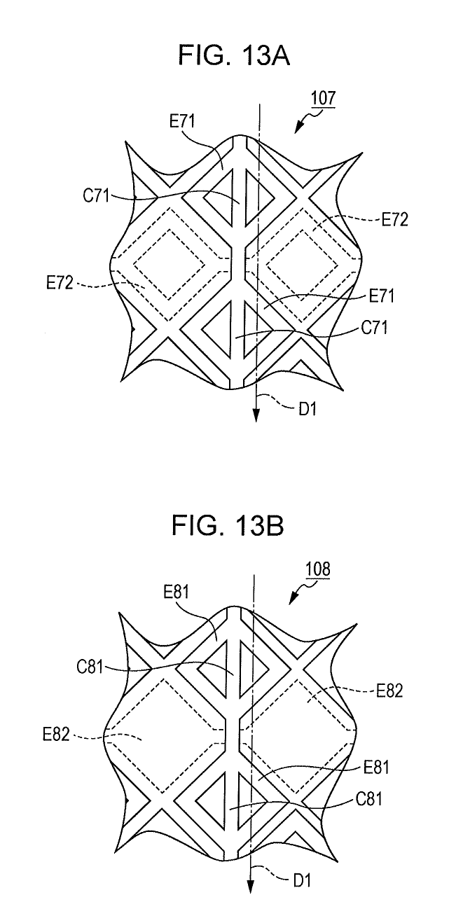

In the above-mentioned second embodiment, a shape is adopted where the first connection portion C21 is provided in the first electrode 21, and a shape is adopted where the second connection portion C22 is provided in the second electrode 22. However, as illustrated in FIG. 13A, in a coordinate input device 107 of the present invention, a shape may also be adopted where no second connection portion is provided in a second electrode E72, and a shape may also be adopted where a first connection portion C71 is provided only in a first electrode E71. In addition, as illustrated in FIG. 13B, in a coordinate input device 108 of the present invention, a shape may also be adopted where an electrode is formed throughout the entire surface of the electrode surface of a second electrode E82 and a first connection portion C81 is provided only in a first electrode E81.

Since, as described above, in the coordinate input device 107 of the present invention, the first connection portion C71 is provided in the first direction D1 within the ring shape of the first electrode E71, it may be possible to reduce the resistance of a first electrode array. Since, owing to this, wiring resistance in a detection path becomes reduced, it may be possible to accelerate a response speed at the time of detection. The coordinate input device 108 also has the same advantageous effect.

### Fourth Example of Modification

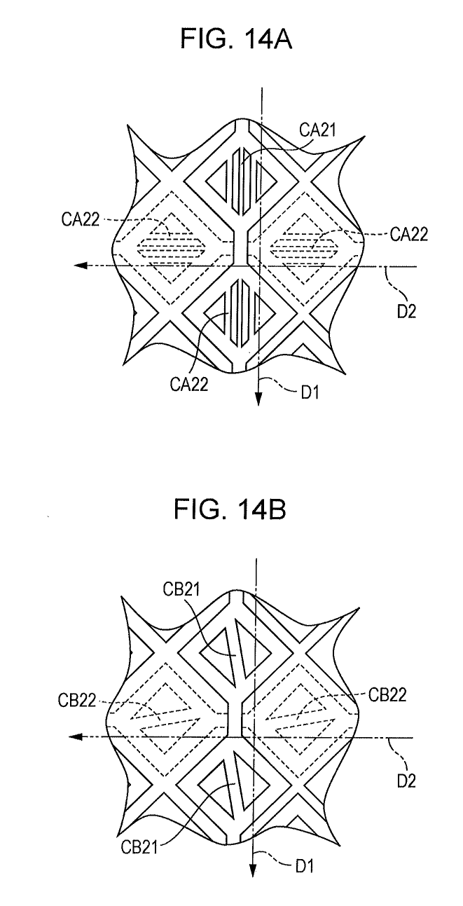

In the above-mentioned second embodiment, a shape is adopted where the first connection portion C21 is provided at a single point in the first electrode 21, and a shape is adopted where the second connection portion C22 is provided at a single point in the second electrode 22. However, as illustrated in FIG. 14A, the connection points of the first connection portion CA21 and the second connection portion CA22 may also be provided at a plurality of points. In addition, the above-mentioned second embodiment, a shape is adopted where the first connection portion C21 is provided in the first electrode 21 so as to be approximately parallel to the first direction D1, and a shape is adopted where the second connection portion C22 is provided in the second electrode 22 so as to be approximately parallel to the second direction D2. However, as illustrated in FIG. 14B, a first connection portion CB21 and a second connection portion CB22 may also be formed so as to be slightly inclined, and it may be only necessary for the first connection portion CB21 and the second connection portion CB22 to be provided in the individual directions (D1, D2).

### Fifth Example of Modification

In the above-mentioned third embodiment, the shape of the first electrode 21 and the shape of the fourth electrode 34 are equal to each other, the shape of the second electrode 22 and the shape of the third electrode 33 are also equal to each other, and this may be a preferable combination. However, the fourth electrode 34 may also have a shape where an electrode is formed throughout the entire surface of an electrode surface, and the outline thereof may also be different from the first electrode 21. In the same way, the third electrode 33 may also have a shape where an electrode is formed throughout the entire surface of an electrode surface, and the outline thereof may also be different from the second electrode 22.

### Sixth Example of Modification

While, in the above-mentioned third embodiment, the third electrode 33 is provided on the one side of the insulation layer 17 and the fourth electrode 34 is provided on the other side of the insulation layer 17, the third electrode 33 may also be only provided on the one side of the insulation layer 17.

### Seventh Example of Modification

While, in the above-mentioned fifth embodiment, the base material 59, the first electrode group G51, and the second electrode group G52 are used, it may be possible to use a transparent base material as the base material 59 and use transparent electrodes as the first electrode group G51 and the second electrode group G52. Owing to this, it may be possible to apply the coordinate input device to a touch panel or the like where the coordinate input device is used as the front surface of a display device, and it may be possible to use the coordinate input device for more various purposes. In addition, since the pattern area of the insulation film portion 58 is small, the insulation film portion 58 may also be applied to a touch panel or the like. However, by using, also for the insulation film portion 58, the same transparent material as the transparent insulation layer T67 used in the above-mentioned sixth embodiment, visibility may be further improved, and the coordinate input device may also be suitably used.

The present invention is not limited to the above-mentioned embodiments, and may be arbitrarily modified within the scope of the purpose of the present invention.

What is claimed is:

1. A coordinate input device of an electrostatic capacitance type, comprising:
a first electrode group including a plurality of first electrode arrays arranged at predetermined intervals; and a second electrode group including a plurality of second electrode arrays arranged at predetermined intervals, wherein the first electrode group and the second electrode group are provided in one surface of a base material, wherein
the first electrode group and the second electrode group are insulated from each other, and laid so as to intersect with each other,
a plurality of first electrodes are linked in a first direction in the first electrode array, a plurality of second electrodes are linked in a second direction in the second electrode array,
the first electrode is displaced from the second electrode in planar view,
the first electrode is ring shaped,
a ground electrode is provided in the one surface of the base material, and the ground electrode is electrically connected to the first electrode and the second electrode.

2. The coordinate input device according to claim 1, wherein
the second electrode is ring shaped.

3. The coordinate input device according to claim 1, wherein
a first connection portion is provided in the first direction within the ring shaped first electrode.

4. The coordinate input device according to claim 2, wherein
a first connection portion is provided in the first direction within the ring shaped first electrode, and a second connection portion is provided in the second direction within the ring shaped second electrode.

5. The coordinate input device according to claim 1, wherein
the first direction and the second direction are perpendicular to each other.

6. The coordinate input device according to claim 5, wherein
outlines of the first electrode and the second electrode are in square shapes.

7. The coordinate input device according to claim 5, wherein
outlines of the first electrode and the second electrode are in hexagonal shapes.

8. The coordinate input device according to claim 1, wherein
the first electrode group, the second electrode group, and an insulation layer used for insulating the first electrode group and the second electrode group from each other are provided on one surface side of the base material,
the first electrode group is provided on one side of the insulation layer, and the second electrode group is provided on the other side of the insulation layer.

9. The coordinate input device according to claim 8, wherein
a third electrode facing the second electrode is provided on the one side of the insulation layer.

10. The coordinate input device according to claim 8, wherein
a fourth electrode facing the first electrode is provided on the other side of the insulation layer.

11. The coordinate input device according to claim 10, wherein
the base material is a transparent base material, the insulation layer is a transparent insulation layer, and
the first electrode group and the second electrode group are transparent electrodes.

12. The coordinate input device according to claim 1, wherein
the first electrode group and the second electrode group are provided in the one surface of the base material, and
an insulation film portion used for insulating the first electrode group and the second electrode group from each other is provided at a position where the first electrode group and the second electrode group intersect with each other.

13. The coordinate input device according to claim 8, wherein
the base material is a flexible base material having flexibility.
